(19) United States
(12) Patent Application Publication
(10) Pub. No.: US 2007/0274162 A1
(43) Pub. Date: Nov. 29, 2007

(54) SPLIT CROWN AND PUSHERS WATCH

(76) Inventor: Christopher Aire, Los Angeles, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/753,530

(22) Filed: May 24, 2007

Related U.S. Application Data
(60) Provisional application No. 60/803,213, filed on May 25, 2006.

(51) Int. Cl. G04B 37/00

(52) U.S. Cl. 368/276

(57) ABSTRACT

A modular wristwatch assembly includes a watch case assembly, a watch movement assembly, and a watch strap. The watch case assembly includes a bezel assembly having split crown and pushers. The crown and the pushers are located on opposite sides of the watch case assembly for ease of accessibility. The crown controls movement of the hour, minute and second hands. The pushers control operation of function dials on the watch.

### BACKGROUND OF THE INVENTION

The present invention relates generally to timepieces. More particularly, the present invention relates to a wristwatch having split crown and pushers.

Wristwatches come in a variety of types including, but not limited to, mechanical windup watches, self-winding or “automatic” mechanical watches, electric or electronic (i.e., battery-powered) analog watches, battery-powered wristwatches with digital time displays (LED (light emitting diode) and constant-display LCD (liquid crystal display)) and analog quartz timing devices.

Wristwatches serve both utilitarian and decorative purposes. A wristwatch has become more than just a tool used to measure the passing of time. A wristwatch also serves as a decorative accessory; a blending of fashion and technology. Typically, a wristwatch has a number of elements including, but not limited to, a watch case having an integral housing, a bezel (e.g., a rotatable numbered dial on top of the watch case), a watch dial or movement contained within the watch case having a watch face, an hour hand, a minute hand and a second hand that indicate the time of day (or an electronic display indicating the time), and a watch band or strap. Additionally, many wristwatches include a crown or knob of a watch stem connected to a watch movement that controls movement of the hour, minute and second hands. A wristwatch may include one or more knobs connected to different watch stems that control different functions. The knob of the watch stem typically extends outwardly from a rim of the watch case and the knob is capable of being partially withdrawn and turned and adjusted in order to adjust time indicating elements of the watch movement for display of the correct time. The knob, however, can detract from the symmetry and smooth lines of the watch case. Just as each visible wristwatch element can contribute to the overall decorative nature of the wristwatch, any element of the wristwatch (e.g., the knob) can also detract from the decorative appearance of the wristwatch. However, the arrangement of the components of the wristwatch is generally uniform with, for example, the knob(s) being on the right side of the wristwatch at or near the three o'clock position. Not only does this ruin the symmetric appearance of the wristwatch by making the watch appear to be lop-sided, the conventional positioning of the knobs on the right side of the watch can make it difficult for someone who wears his or her watch on his or her right wrist to use the knobs to adjust the hands of the watch while wearing the wristwatch.

Therefore, there is still room for improving the look of a wristwatch and accessibility of its components. For example, the ability to provide a watch with a symmetrical appearance or, at the very least, a watch that places elements in unconventional positions that provides easier access to those elements, is desirable from both decorative and functional standpoints.

Accordingly, there is a need for a watch that allows a wristwatch wearer to more easily access components of the watch. There is a further need for a watch that streamlines the look of the watch case by positioning knob(s) in aesthetically pleasing positions. The present invention fulfills these needs and provides other related advantages.

Other features and advantages of the present invention will become apparent from the following more detailed description, taken in connection with the accompanying drawing which illustrate, by way of example, the principals of the invention.

### SUMMARY OF THE INVENTION

The present invention is directed toward a wristwatch assembly having a watch case and a watch movement assembly disposed therein. The watch movement assembly comprises a watch movement, a face, an hour hand and drive pin, a minute hand and drive pin, a second hand and drive pin, and a function dial having a dial hand and drive pin. A movement control knob on one side of the watch case engages the watch movement assembly. The movement control knob controls the movement of the hour, minute and second hands through their respective drive pins. At least one pusher knob is positioned on an opposite side of the watch case from the movement control knob. The pusher control knob controls the operation of the dial hand and drive pin on the function dial.

The wristwatch assembly may include first and second pusher knobs, both located on the opposite side of the watch case from the movement control knob. The first pusher knob controls operation of the dial hand and drive pin on the function dial. The second pusher knob resets the operation of the dial hand and drive pin on the function dial. The watch movement assembly may include three function dials, each having separate dial hands and drive pins. The three function dials are calibrated so as to operate in unison.

The watch movement assembly further includes a date dial which is controlled by the movement control knob. In addition, the hour, minute, second and dial hands may be coated with a self-illuminating substance, i.e., glow-in-the-dark.

Other features and advantages of the present invention will become apparent from the following more detailed description taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a watch of the present invention;

FIG. 2 is a top plan view of the watch of FIG. 1;

FIG. 3 is an elevation of the right side of the watch taken along line 3-3 of FIG. 2;

FIG. 4 is an elevation view of the left side of the watch taken along line 4-4 of FIG. 2;

FIG. 5 is a bottom plan view of the watch of FIG. 1;

FIG. 6 is an enlarged sectional view of area 6 of FIG. 5;

FIG. 7 is a sectional view of the watch take along line 7-7 of FIG. 6;

FIG. 8 is a sectional view of the watch taken along line 8-8 of FIG. 2; and

FIG. 9 is a sectional view of the watch taken along line 9-9 of FIG. 2.

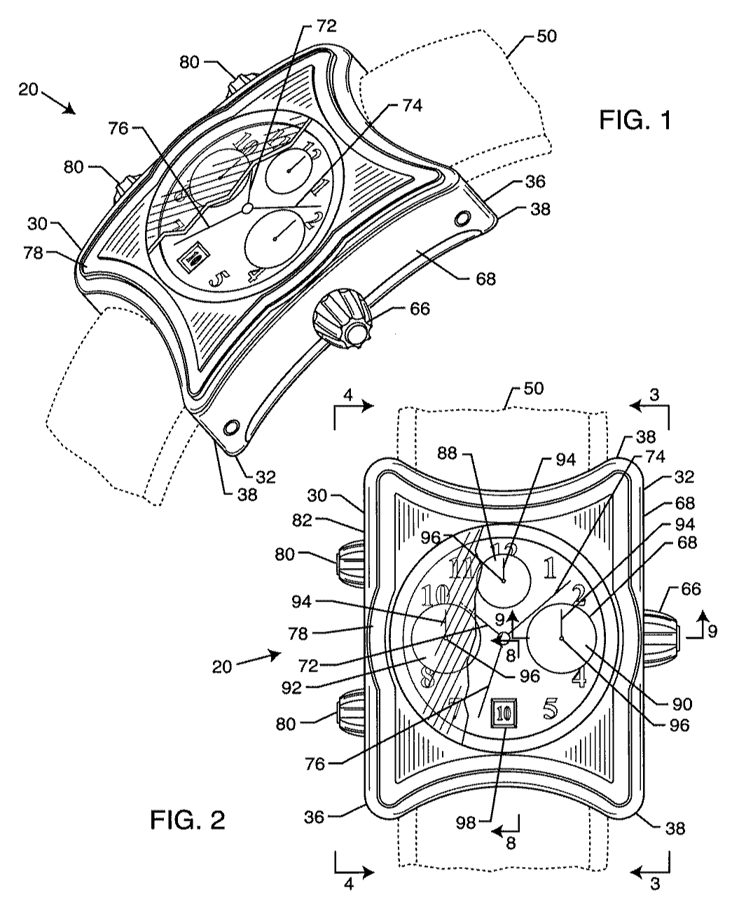

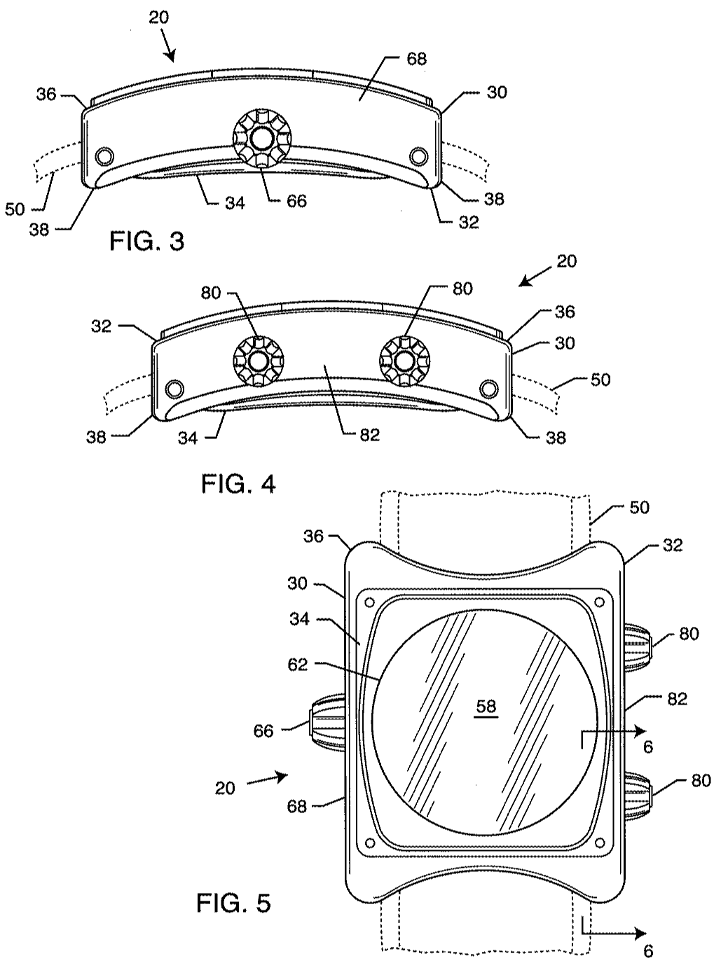

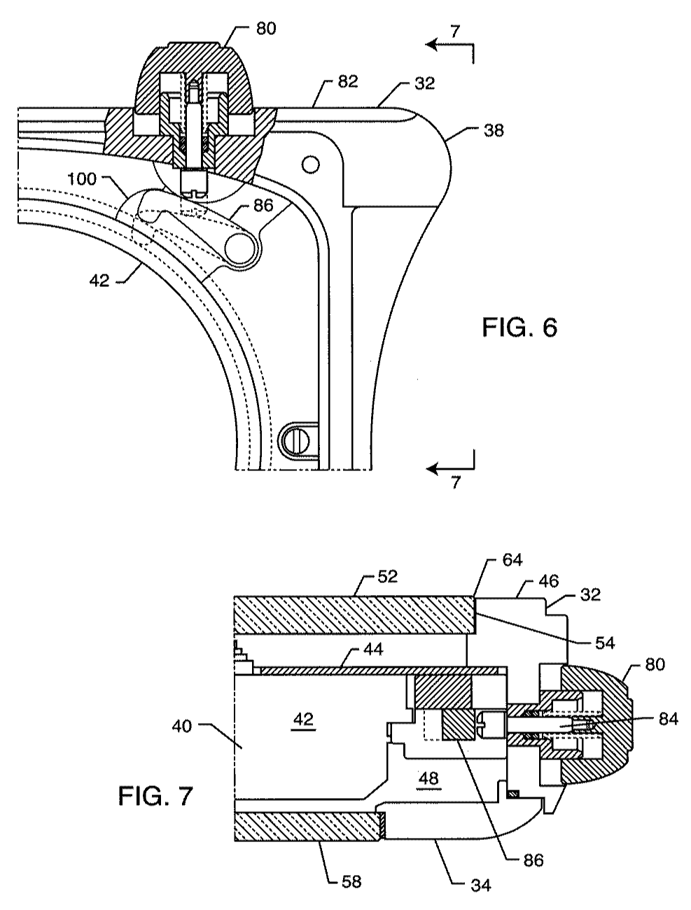

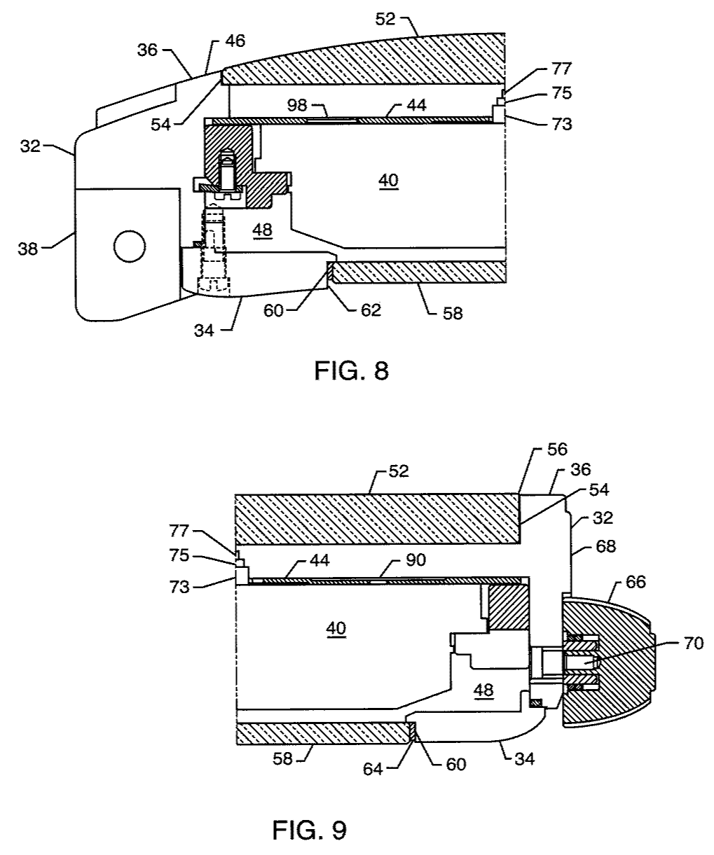

### DETAILED DESCRIPTION OF THE PREFERRED EMBODIMENTS

As shown in the accompanying drawings for purpose of illustration, the present invention resides in a wristwatch assembly, generally referred to by the reference number 20. By way of illustration, the wristwatch assembly 20 is depicted as being of an analog, chronometer type with three function dials including, without limitation, a stopwatch function having a twelve hour counter 88, a thirty minute counter 90, a sixty second counter 92 or the like. The present invention is equally applicable to a single function analog wristwatch, a single or multi-functional digital wristwatch or a combination analog and digital wristwatch.

The wristwatch assembly 20 includes a watch case assembly 30, a watch movement assembly 40 disposed within the watch case assembly 30, and a watch strap 50 detachably connected to the watch case assembly 30.

The watch case assembly 30 includes a housing 32 formed by a back plate assembly 34 and a bezel assembly 36 removably connected together in a conventional manner to provide the housing 32 with an environmental seal. The housing 32 may be a variety of shapes including, without limitation, a generally cylindrical shape, a rectangular shape, a square shape or the like. Two pairs of wrist band lugs 38 extend from the housing 32 to enable attachment of the watch band or strap 50 to the housing 32. Each pair of wrist band lugs 38 are disposed on opposite sides of the housing 32. Each end of the watch strap 50 is connected by a hinge pin (not shown for clarity) to band-receiving ends of a respective pair of wrist band lugs 38 in a conventional manner. The watch strap 50 may be various types including, but not limited to, a leather strap, a plastic strap, a metal strap or a combination of the aforementioned types of straps. The housing 32 may be made from a variety of materials including, but not limited to, aluminum, gold (plated or solid), platinum (plated or solid), stainless steel, silver, plastic or the like. In the alternative, gem stones may be embedded on the surface of the housing 32.

The watch movement assembly 40 includes a watch movement 42 having a watch face or dial 44 disposed thereon. The watch movement 42 is sized and shaped in order to fit within the watch case assembly 30. Conventional components of the watch movement 42 not shown for clarity include a winding-mechanism that winds a mainspring; a setting-mechanism (usually connected to the winding-mechanism by common parts for altering the position of the hands of the watch); and a dial-train fitted under the dial 44 for transmitting the rotation of a minute-pinion to the hour hand. The watch dial 44 which serves as the indicating “face” of the watch 20, usually in the form of a plate of metal or other material, bearing various markings to show at least the hours, minutes and seconds by means of numerals, divisions or symbols of various types, printed, raised, applied and/or combined with other skills like “cloisonné” enamel, diamond-set or “pave” decoration. Gem stones may be embedded on the surface of the watch face 44 within a decorative channel 78 along a perimeter of an outer surface of the upper plate 46 of the housing 32.

The bezel assembly 36 includes an upper plate 46 defining, in conjunction with the back plate assembly 34, an inner cavity 48 into which the watch movement assembly 40 can be inserted. A watch crystal 52, preferably made from a scratch-resistant mineral glass, is positioned within a niche 54 of the upper plate 46 of the bezel assembly 38 between the dial 44 and an aperture 56 in the upper plate 46 aligned with the watch face 44. The back plate assembly 34 includes a watch crystal 58, preferably made from a scratch-resistant mineral glass, positioned within a niche 60 of the back plate assembly 34 between the watch movement 42 and an aperture 62 in the back plate assembly 34 aligned with the watch movement 42. An environmental seal 64 is positioned about each crystal 52, 58 within its respective niche 54, 60.

A watch movement control knob crown 66 extends through a right side wall 68 of the housing 32. This knob 66 is connected via a watch stem 70 to the watch movement 42. The knob 66 is capable of being partially withdrawn and turned and adjusted in order to adjust the time indicating elements of the watch movement 42 for display of the correct time. Also associated with both the watch movement 42 and the watch face 44 are hour, minute and second hands 72, 74, 76 operationally connected to the watch movement 44 by respective drive pins 73, 75, 77. The hour, minute and second hands 72, 74, 76 may be made from metal and covered with a decorative fluorescent coating to enable the hour, minute and second hands 72, 74, 76 to glow-in-the-dark. The watch hands 72, 74, 76 are usually made of a thin, light piece of metal, very variable in form, which moves over the graduated watch dial 44. Usually for each indication of time (i.e., hour, minute, second) one specific hand is needed (i.e., hands 72, 74, 76). The hands 72, 74, 76 may come in a variety of styles, qualities and colors and may be made from various materials including, but not limited to, solid gold, tempered steel, brass or the like with the materials protected and/or decorated either by a thin galvanized layer of gold, rhodium or some kind of lacquer.

A number of pusher knobs 80 extend through a left side wall 82 of the housing 32. Each pusher knob 80 is connected via a spring-loaded stem 84 to a spring-loaded pivotal lever 86 capable of engaging the watch movement 42 when the pusher knob 80 is depressed by a wearer and automatically disengages from the watch movement 42 when the pusher knob 80 is released by the wearer. The pusher knobs 80 activate/deactivate the functions of first, second, and third small, calibrated dials 88, 90, 92 on the watch face 44. The dials 88, 90, 92 perform a stopwatch function and serve, respectively, as a twelve hour counter, a thirty minute counter, and a sixty second counter. Each dial 88, 90, 92 includes a dial hand 94. Each hand 94 is connected to the watch movement 42 by a drive pin 96 to display, respectively, hour, minute and seconds. The watch face 44 also includes a dial 98 connected to the watch movement 42 that displays a day of the month. Alternatively, day of the week and month dials connected to the watch movement 42 may also be disposed on the watch face 44. The dial hands 94 may be made from metal and covered with a decorative fluorescent coating to enable the dial hands 94 to glow-in-the-dark.

While the wristwatch 20 has been described with the crown knob 66 extending through the right side wall 68 of the housing 32 and the pusher knobs 80 extending through the left side wall 82 of the housing 32, the respective positions of the knobs 66, 80 may be reversed. Additional knobs 66, 80 that provide other functionality may be added to the wristwatch 20.

The watch face 44, regardless of configuration, may be made from any thin, suitable material and may be finished in any desired manner. For example, the watch face 44 may include a black face with white dials 88, 90, 92, white hour, minute, and second hands 72, 74, 76, and black hands 94. Alternatively, the previously described color scheme may be reversed or other color schemes may be used to provide a contrast between the watch face 44, the dials 88, 90, 92, and the hands 72, 74, 76, 94. Likewise, the watch face 44 may include a color scheme to complement that of the bezel assembly 36.

The watch movement 42 may be any existing type, with the watch face 44 adapted for that particular type, including, but not limited to a mechanical type (either automatic (self winding) or a wind-up type), a digital type, a quartz electronic type, or any other available type.

In operation, when a user wishes to engage a stopwatch function of the watch 20, the user depresses one of the pusher knobs 80 which, in turn, pushes the spring-loaded stem 84 connected to the knob 80 so that an end of the stem 84 engages an adjacent spring-loaded pivotal lever 86 which, in turn, mechanically swings out of a recess 100 to mechanically engage the watch movement 42. Both the spring-loaded pivotal lever 86 and the watch stem 84 automatically return to their original positions once the pusher knob 80 is released by the wearer. Engagement of the lever 86 with the watch movement 42 activates the timing functions of the first, second, and third dials 88, 90, 92 by causing the drive pin 96 of each dial 88, 90, 92 to turn each respective dial hand 94 clockwise to indicate the passage of time in up to twelve hour, up to thirty minutes, and up to sixty second increments on each respective dial 88, 90, 92. When the user desires to end the stopwatch function, the user again depresses one of the pusher knobs 80 which, in turn, pushes the spring-loaded stem 84 connected to the knob 80 so that the end of the stem 84 engages the adjacent spring-loaded pivotal lever 86 which, in turn, mechanically swings out of the recess 100 to mechanically engage the watch movement 42. The watch movement 42 then deactivates the drive pins 96 of each dial 88, 90, 92 which, in turn, causes the respective dial hands 94 to cease clockwise movement. When the user desires to re-set the dial hands 94 into a zero or twelve o'clock position, the user depresses the other of the pusher knobs 80 which, in turn, pushes an associated spring-loaded stem 84 connected to that knob 80 so that the end of that stem 84 engages an adjacent spring-loaded pivotal lever 86 which, in turn, mechanically swings out of its recess 100 to mechanically engage the watch movement 42. The watch movement 42 then activates the drive pins 96 of each dial 88, 90, 92 which, in turn, causes the respective dial hands 94 to moves into the zero or twelve o'clock position.

Although embodiments have been described in detail for purposes of illustration, various modifications may be made without departing from the scope and spirit of the invention.

What is claimed is:

1. A wristwatch assembly, comprising:
a watch case;
a watch movement assembly disposed within the watch case, the watch movement assembly comprising a watch movement, a face, an hour hand and drive pin, a minute hand and drive pin, a second hand and drive pin, and a function dial having a dial hand and drive pin;
a movement control knob on one side of the watch case for engaging the watch movement assembly and controlling movement of the hour, minute and second hands and their respective drive pins; and
a pusher knob on an opposite side of the watch case for controlling operation of the dial hand and drive pin on the function dial.

2. The wristwatch assembly of claim 1, wherein the function dial comprises three calibrated dials corresponding to hours, minutes and seconds, each dial having a separate dial hand and drive pin.

3. The wristwatch assembly of claim 1, wherein the pusher knob has a spring loaded stem which, when depressed, engages a spring loaded pivotal lever for engaging the watch movement.

4. The wristwatch assembly of claim 1, comprising a first pusher knob and a second pusher knob, both on an opposite side of the watch case.

5. The wristwatch assembly of claim 4, wherein the first pusher knob controls operation of the dial hand and drive pin on the function dial.

6. The wristwatch assembly of claim 4, wherein the second pusher knob resets the operation of the dial hand and drive pin on the function dial.

7. The wristwatch assembly of claim 1, wherein the watch movement assembly further includes a date dial.

8. The wristwatch assembly of claim 7, wherein the movement control knob controls the date dial.

9. The wristwatch assembly of claim 1, including a self-illuminating substance applied to surfaces of the hour, minute, second or dial hands.

10. A wristwatch assembly, comprising:
a watch case;
a watch movement assembly disposed within the watch case, the watch movement assembly comprising a watch movement, a face, an hour hand and drive pin, a minute hand and drive pin, a second hand and drive pin, and three calibrated function dials corresponding to hours, minutes and seconds, each dial having a separate dial hand and drive pin;
a movement control knob on one side of the watch case for engaging the watch movement assembly and controlling movement of the hour, minute and second hands and their respective drive pins; and
first and second pusher knobs on an opposite side of the watch case for controlling operation of the dial hands and drive pins on the function dials.

11. The wristwatch assembly of claim 10, wherein the pusher knobs each have a spring loaded stem which, when depressed, engages a spring loaded pivotal lever for engaging the watch movement.

12. The wristwatch assembly of claim 10, wherein the first pusher knob controls operation of the dial hand and drive pin on the function dial.

13. The wristwatch assembly of claim 10, wherein the second pusher knob resets the operation of the dial hand and drive pin on the function dial.

14. The wristwatch assembly of claim 10, wherein the watch movement assembly further includes a date dial.

15. The wristwatch assembly of claim 14, wherein the movement control knob controls the date dial.

16. The wristwatch assembly of claim 10, including a self-illuminating substance applied to surfaces of the hour, minute, second or dial hands.

17. A wristwatch assembly, comprising:
a watch case;
a watch movement assembly disposed within the watch case, the watch movement assembly comprising a watch movement, a face, an hour hand and drive pin, a minute hand and drive pin, a second hand and drive pin, a date dial, and a function dial having a dial hand and drive pin;
a movement control knob on one side of the watch case for engaging the watch movement assembly and controlling movement of the hour, minute and second hands and their respective drive pins; and
first and second pusher knobs on an opposite side of the watch case for controlling operation of the dial hand and drive pin on the function dial.

18. The wristwatch assembly of claim 17, wherein the function dial comprises three calibrated dials corresponding to hours, minutes and seconds, each dial having a separate dial hand and drive pin, wherein the first pusher knob controls operation of the dial hands and drive pins on the function dials, wherein the second pusher knob resets the operation of the dial hands and drive pins on the function dials, and wherein the movement control knob activates the date dial.

19. The wristwatch assembly of claim 17, wherein the first and second pusher knobs each have a spring loaded stem which, when depressed, engages a spring loaded pivotal lever for engaging the watch movement.

20. The wristwatch assembly of claim 17, including a self-illuminating substance applied to surfaces of the hour, minute, second or dial hands.
